(19) United States
(12) Patent Application Publication
(10) Pub. No.: US 2011/0192422 A1
(43) Pub. Date: Aug. 11, 2011

(54) PROCESS FOR CLEANING ENGRAVED CYLINDERS USED IN PRINTING AND PACKAGING INDUSTRY FROM ADHESIVE AND/OR INK RESIDUES

(75) Inventors: Ernesto REVERCHON, Salerno (IT); Giovanna Della Porta, Cava dei Tirreni (SA) (IT)

(73) Assignee: UNIVERSITA' DEGLI STUDI DI SALERNO, Fisciano (SA) (IT)

(21) Appl. No.: 13/090,169

(22) Filed: Apr. 19, 2011

Related U.S. Application Data
(63) Continuation of application No. 11/885,986, filed on Nov. 5, 2008, now abandoned.

(30) Foreign Application Priority Data
Mar. 10, 2005 (US) SA2005A000007

(51) Int. Cl. B08B 7/00; B08B 3/10; B08B 3/08

(52) U.S. Cl. 134/13

(57) ABSTRACT

A process for the removal of dry adhesives and/or inks from the surface and from the interior of the cells of the engraved cylinders used in printing and coupling processes, using a supercritical mixture formed by one or more organic solvents and a supercritical fluid, preferably consisting of supercritical carbon dioxide. The microscopic cells of the engraved cylinders used in printing industry or of the cylinders used for film coupling in packaging industry are thoroughly and easily cleaned by a process comprising the steps of forming the said supercritical mixture, delivering it in a high pressure autoclave previously filled with the engraved cylinders to be cleaned, cleaning for a given residence time, eliminating the organic solvent residue in the autoclave by washing it with supercritical fluid and precipitating the extracted inks and/or adhesives in one or more separators located downstream the autoclave.

The present invention concerns a procedure for cleaning engraved cylinders used in printing and packaging industry from adhesive and/or ink residues. More specifically, the present invention relates to a process for the removal of dry adhesives and/or inks from the surface and from the interior of the cells of the engraved rollers used in printing and coupling processes.

Printing or film coupling processes use engraved steel cylinders coated with a copper layer, having a thickness of about 2 mm. The engraving process (mechanical or electromechanical) produces the so called “honeycomb” structure on the copper layer. Particularly, microscopic cells having size ranging from 5 to 100 μm, generally quadrangular in shape, are engraved on the cylinder surface. Then, the cells are coated with chromium, by a galvanic process, to improve their mechanical resistance and durability. Thus, the engraved cells are ready to carry inks or adhesives, performing as small rotating basins.

During their use, the said cells are progressively filled up with residual dry ink and/or adhesive, that reduce their efficiency and, therefore, the functionality of the overall process. As a consequence, to assure the continuous quality of printing or film coupling in time, it is necessary to frequently remove the solid residues from the microscopic cells.

Cells cleaning is very complex, due to their microscopic size. The techniques conventionally used are as follows.
Soaking for up to 30 days in a specific organic solvent bath, followed by manual or mechanical abrasion. The manual cleaning, performed with metallic brushes, takes a long time and can damage the cylinder coating. Moreover, the brush bristle diameter is normally larger than the cells and thus the dry material from the cell bottom will not be completely removed.
High pressure or ultrasonic cleaning in macro-washing machines containing caustic liquids or organic solvents. Particularly, ultrasounds are used to generate microscopic bubbles that explode on the cells surface. The explosion forces the caustic liquid into the cells, thus removing the solid residue. This method is quite expensive and requires long processing times.

The U.S. Pat. No. 5,490,460 discloses an automated process for removing ink residues from printing cylinders used in flexography or rotogravure processes, wherein a printing cylinder is placed in a tank adapted to receive it and is immersed in a suitable liquid cleaning solution and sprayed on its surface with the cleaning solution by a “spraying-under-immersion” technique, while rotating the printing cylinder.

It is evident that the adoption of improved cleaning technologies can positively affect the process cost and effectiveness and, therefore, the company profit. An innovative cleaning process is intended to be more efficient and less expensive than the conventional ones, and, at the same time, more environmentally friendly.

In the frame of the research that led to the present invention, the possibility to remove dry adhesives and/or inks from the cells of the engraved cylinders used in printing and coupling processes by using supercritical solutions or dense gases has been considered.

A supercritical fluid is a compound used at temperatures and pressures higher than those of its critical point; whereas, a dense gas is defined as a fluid used in the proximity of its critical point. Each pure compound, in the region of its state diagram in which the pressure is higher than the critical pressure (P_{c}) and temperature is higher than the critical temperature (T_{c}), shows properties that for many aspects are intermediate between those of gases and liquids. At supercritical conditions, a fluid shows densities similar to the liquid phase, but a gas-like viscosity and a diffusion coefficient higher by one or two orders of magnitude than the diffusion coefficient of the liquid phase. Moreover, a supercritical fluid can exhibit a solvent power close to the one of the liquid phase and a surface tension near to zero. This last characteristic is very favourable for the treatment of microscopic cavities.

The solvent power of a supercritical fluid is adjustable with continuity; therefore, using the same fluid, different process conditions can be obtained in various sections of a plant. It is also easy to obtain a fast and complete elimination of the solvent from the extract by simple decompression. The characteristics described are also shown by mixtures of two or more fluids, when these are at pressures and temperatures above the “mixture critical point”.

The most widely used supercritical fluid is supercritical carbon dioxide (SC—CO₂). It is non-toxic, not flammable and not corrosive. Moreover, it is cheep and its critical values of pressure and temperature (T_{C}=31.1° C.; P_{C}=73.8 bar) are easy to be obtained on the industrial scale.

Supercritical fluids have been proposed for the cleaning of several structures in the field of microelectronics and electrical engineering, and for the cleaning of metallic surface and instruments in the medical field. Several scientific papers and patents exist in which SC—CO₂ and/or other supercritical fluids are proposed as solvents for cleaning and removing polluting agents. For example, in the international patent application WO 2004/059383 supercritical solutions with supercritical CO₂ and a fluoride source are proposed to clean semiconductor substrates. As further examples, the US patent application US 2004/003831, the U.S. Pat. No. 6,558,475 and the international patent application WO 2003/057811 all disclose processes for the supercritical cleaning of semiconductor wafers. These processes employ supercritical CO₂ variously mixed with co-solvents, additives, surfactants and/or chelating agents. The various patents differ in the specificity of the impurity to be removed and in the proposed supercritical fluid.

Cleaning processes based on supercritical fluids have been proposed also in the biomedical field. By way of example, the US patent application US 2003/0021825 and the Japanese patent application JP 2001/178801 propose the utilization of supercritical fluids for the cleaning, respectively, of implantable medical devices and of medical appliance such as surgical instruments.

Supercritical fluids, either pure or in solution with organic solvents, have not been proposed, so far, for use in the removal of dry adhesive and/or ink residues from the microscopic cells of the engraved cylinders used in printing industry or from the cells of the engraved cylinders used for film coupling in packaging industry. As a matter of fact, most of the ink and adhesive compounds used in printing and packaging industry are not soluble in supercritical CO₂, since they are not compatible as to polarity and molecular structure. According to the process proposed by the present invention, the cleaning of engraved cylinder cells can be performed using suitable mixtures of organic solvents and carbon dioxide at supercritical conditions. The organic solvents can be easily separated from the CO₂ and recycled at the end of the cleaning process.

According to the present invention there is proposed a process for cleaning the microscopic cells of engraved cylinders using supercritical solutions formed by an organic solvent and supercritical CO₂. Supercritical solutions show a surface tension close to zero and high diffusivities, and therefore they can rapidly penetrate in the microscopic cells inducing a fast and complete cleaning.

Further, the proposed process is particularly effective because the supercritical mixtures can induce the foaming of dry residues; as a consequence, the residue surface area exposed to the supercritical mixture is largely increased. This favours a complete removal of the residue from the bottom of each single cell and a very fast cleaning.

Therefore, the present invention specifically provides a process for cleaning the cells of engraved cylinders used in printing and packaging industries from adhesive or ink residues, which process uses a mixture formed by one or more organic solvents and a fluid, and comprises the following steps:
a) forming the mixture in a mixer;
b) delivering said mixture in an autoclave previously filled with the engraved cylinders;
c) cleaning for a residence time of from 5 to 190 minutes;
d) eliminating the organic solvent residue in the autoclave by washing it with fluid;
e) precipitating the extracted inks or adhesives in one or more separators located downstream the autoclave,
   characterized in that said mixture is a supercritical mixture containing from 70 to 90% by weight of said one or more organic solvents and a supercritical fluid, in that said mixer is a vessel withstanding operating pressures up to 400 bar and in that said autoclave is a vessel withstanding operating pressures up to 400 bar.

As a rule, step e) of the process includes precipitating the extracted residues from the supercritical mixture by spray extraction methods.

In addition, the proposed process can also contain the following step: f) depressurizing the supercritical mixture to recover the organic solvent and the supercritical fluid, that can be re-used in the process.

The compounds selected as supercritical fluid are preferably gaseous at room conditions and can be one or more compounds chosen from the group consisting of: carbon dioxide, nitrogen protoxide, trifluoromethane, propane. Supercritical carbon dioxide is preferably used.

The one or more organic solvents used in the proposed process can be chosen from the group consisting of: acetone, chloroform, diethyl- or dimethylsulfoxide, ethyl acetate, propyl acetate, isopropyl acetate, n-butyl acetate, isobutyl acetate, methyl glycol acetate, amyl acetate, ethyl glycol acetate, methyl amyl acetate, tetrahydrofurane, methanol, ethanol, propanol, butanol, iso-butanol, n-hexane, cyclohexane, methyl furane, ethyl ether, N-methyl pyrrolidone, furane, acetonitrile.

According to some specific embodiments of this invention, said engraved cylinders are used in film coupling processes and said adhesive residues are chosen from the group consisting of: polymaleic, polyacrylic, polyurethane, polyvinyl, polyacrylic and polyamide resins.

According to some further embodiments of the invention, said engraved cylinders are used in printing processes and said ink residues are formed by a system resin+additive+pigment, commonly used in printing industries and chosen from the group consisting of: systems with yellow, red, blue, violet, green, black pigment mixed with polymeric resins, which in turn are chosen from polymaleic, polyacrylic, polyurethane, polyvinyl, polyacrylic and polyamide resins.

By preference, in the steps a) and b), i.e. in the mixer and in the autoclave, the supercritical mixture operates at a pressure range between 40 and 400 bar (preferably between 100 and 200 bar), and at a temperature range between 30 and 100° C. (preferably between 40 and 60° C.). An example of operating conditions may be in the range between 80-150 bar and 40-80° C. for solutions of N-methylpyrrolidone and carbon dioxide.

As pointed out, in step c) the residence time of the engraved cylinder in the autoclave can vary between 5 and 190 minutes, and preferably is set between 10 and 145 minutes.

The process according to the invention can be carried out by means of an apparatus for cleaning the cells of engraved cylinders used in printing and packaging industries from adhesive and/or ink residues, by a process using a supercritical mixture formed by one or more organic solvents and a supercritical fluid, said apparatus comprising the following components:
A) a mixer to be fed with two or more organic solvents and a supercritical fluid;
B) an autoclave suitable to house the said engraved cylinders for the cleaning operation with said supercritical mixture;
C) one or more separators operating in series for the precipitation of the extracted inks and/or adhesives.

In some preferred embodiments of the invention, the concerned apparatus further comprises a system for the recovery of the organic solvents and the supercritical fluid, which system comprises a separator equipped with a depressurization system.

Further, the apparatus according to the invention can comprise a system for recompressing one or more components of said mixture to supercritical conditions.

The advantages of the claimed process are: a fast and complete removal of the dry residue from the microscopic cells due to the supercritical fluid mixture characteristics: surface tension close to zero and high diffusivity; a reduction of the cleaning times from hours and weeks to several minutes and a low environmental impact due to the fractional separation of the residual extract and the complete recovery of solvents and CO₂ used. The claimed process may be also less expensive than the conventional chemical wash, due to the easy solvent recovery.

The specific features of the invention, as well as the advantages thereof and its operating mode, will be more evident with reference to the detailed description shown below by way of example, together with some experimental results obtained by carrying out the invention. The invention is further illustrated in the enclosed drawings, wherein:

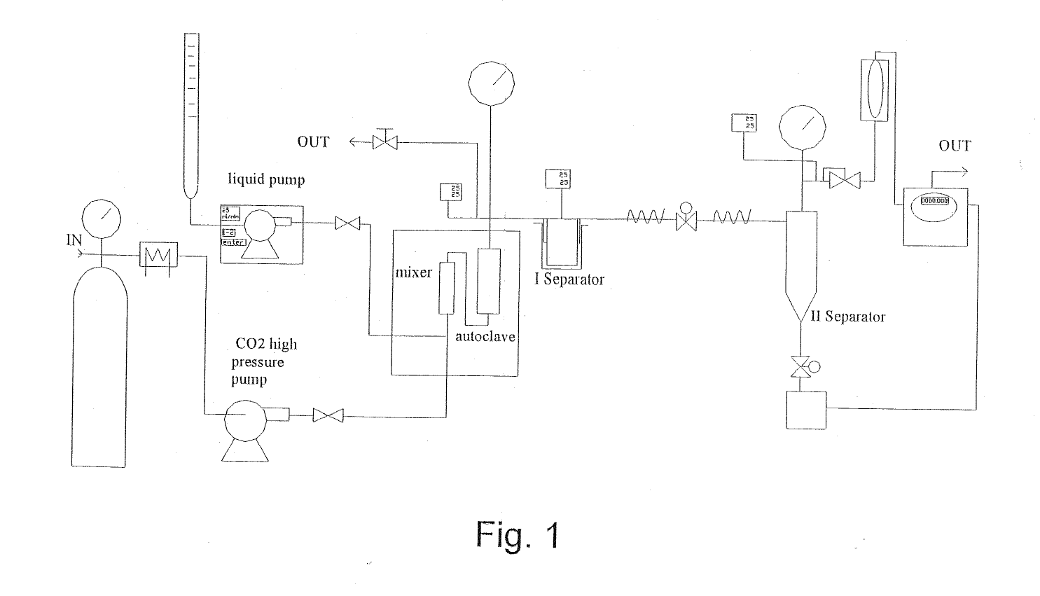

FIG. 1 shows a schematic representation of an apparatus for cleaning engraved cylinders from ink and/or adhesive residues according to the invention; and

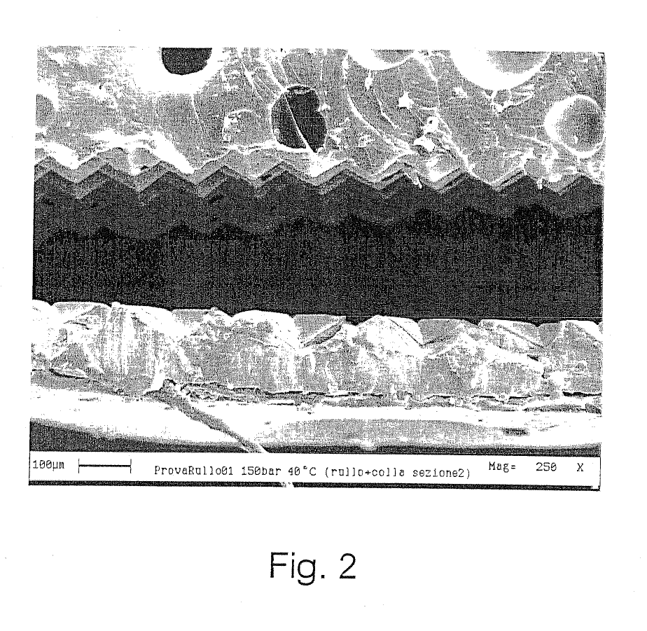

FIG. 2 shows a scanning electron microscope (SEM) image of an engraved roll section after cleaning according to the invention (lower part of the image), and the removed adhesive film (upper part of the image).

In the process claimed, the selected supercritical mixture is obtained in a mixer and then delivered to the cleaning autoclave previously loaded with the engraved cylinders. The dry inks and/or adhesive residues contained in the microscopic cells are contacted with the supercritical mixture at a given flow rate and for a fixed period of time. The supercritical mixture induces, first, the dry residue foaming, an then its rapid removal from the cells. A fast and complete cleaning is obtained.

The mixture at the exit of the cleaning autoclave (extracted substance+CO₂+organic solvent) is then delivered to a first separator, where, by changing the mixture composition and, eventually, the operating pressure and temperature, the extracted material is precipitated and recovered. The supercritical mixture at the exit of the first separator is fed to a second separator in which the de-mixing of the organic solvent from the CO₂ is obtained by simple decompression. Both CO₂ and organic solvents can be recycled.

The static mixer is a vessel containing metallic packing to increase the contact surface between the two fluids. The cleaning autoclave is a stainless steel vessel, usually cylindrical, designed to operate at pressures up to 500 bar and in a range of temperatures from 30 to 200° C. The first separator is designed for an independent temperature and pressure control and with the possibility of changing the mixture composition to realize the extracted residues fractionation by spray extraction methods.

In the second separator the liquid solvent precipitation and its separation from the CO₂ is obtained. Temperature and pressure controls complete the system.

### EXAMPLE 1

### Cleaning of Polyurethane Adhesive Using a Supercritical Mixture of N-methyl pyrrolidone and CO₂

N-methylpyrrolidone (NMP) and CO₂ were mixed at weight ratios between 0.5 and 90% of NMP (preferably 80% of NMP by weight) in a static mixer (internal volume 250 dm³). The solution was used in a pressure range of 80-300 bar (preferably at 150 bar) and in a temperature range of 30-100° C. (preferably at 40° C.); the solution was delivered to the cleaning autoclave with a flow rate ranging between 0.8 and 5 kg/h (preferably 1 kg/h). The autoclave (internal volume 500 dm³) was loaded with pieces of engraved cylinder (surface area 9 cm²) on which the polyurethane adhesive was previously spread.

The supercritical solution, first, induced the polyurethane foaming, increasing the polymer surface area exposed to the supercritical mixture. Then, it caused the complete adhesive removal from the bottom of the microscopic cells. The process was performed for a variable period of time ranging between 10 and 140 minutes (usually 30 minutes).

Downstream the autoclave, the solution was fed to the first separator that operates at pressures between 30 and 200 bar (preferably 90 bar) and temperatures ranging between 40 and −30° C. (preferably at 40° C.). The first separator allows the adhesive precipitation and its recovery using the spray extraction technique.

The solution at the exit of the first separator is, then, delivered to the second separator operating at pressures between 80 and 10 bar (preferably 10 bar) and at temperatures between 0 and 25° C. (preferably 20° C.). In the second separator, NMP is precipitated and recovered by decompression, whereas, CO₂ is separated as gas.

By operating at process conditions of 150 bar, 40° C. with a flow rate of 1 kg/h for 30 min, with a N-methylpyrrolidone mass fraction of 80%, the following results were obtained:

| | |
|---|---|
| weight of engraved cylinder sample | 0.8865 g |
| weight of engraved cylinder sample laded with polyurethane | 0.8900 g |
| adhesive | |
| weight of engraved cylinder sample after SC-cleaning | 0.8865 g |
| residual polyurethane adhesive on the engraved cylinder | 0.0000 g |
| sample | |

FIG. 2 shows an image obtained by Scanning Electron Microscope (SEM) that illustrates an engraved roll section after cleaning (lower part of the image) and the removed adhesive film (upper part of the image) obtained according to Example 1. From this SEM image it is clear that the thickness and the shape of the cells are equivalent to the shape and the depth of the adhesive film removed. The foaming of the polyurethane adhesive is also evident.

### EXAMPLE 2

### Cleaning of Red Ink in Polyvinyl Resin Using a Supercritical Mixture of ethyl acetate and CO₂

Ethyl acetate (EA) and CO₂ were mixed at weight ratios between 0.5 and 90% of EA (preferably 70% of EA by weight) in a mixer (internal volume 250 dm³). The solution was used in a pressure range of 80-300 bar (preferably at 130 bar) and in a temperature range of 30-100° C. (preferably at 40° C.). The solution was delivered to the cleaning autoclave with a flow rate ranging between 0.4 and 5 kg/h (preferably 1 kg/h). The autoclave (internal volume 500 dm³) was loaded with pieces of engraved cylinder (surface area 9 cm²) on which the polyvinyl resin plus red ink was previously spread. The cleaning was performed for a period of time ranging from 10 to 140 minutes (preferably 40 minutes).

Downstream the cleaning autoclave, the mixture was fed to the first separator, that operates at pressures between 30 and 200 bar (preferably 80 bar) and temperatures ranging between 40 and −30° C. (preferably at 40° C.). The first separator allows the extracted ink precipitation and its recovery using the spray extraction technique.

The solution at the exit of the first separator is, then, delivered to the second separator operating at pressures between 15 and 10 bar (preferably 10 bar) and at temperatures between 0 and 25° C. (preferably 20° C.). In the second separator, EA is precipitated and recovered by decompression, whereas CO₂ is separated as gas. The EA recovered in the second separator still contained 10% by weight of red ink.

By operating at the process conditions of 130 bar, 40° C. with a flow rate of 1 Kg/h for 40 min, with an ethyl acetate mass fraction of 80%, the following results were obtained:

| | |
|---|---|
| weight of engraved cylinder sample | 0.9560 g |
| weight of engraved cylinder sample dirty of polyvinyl red ink | 0.9569 g |
| weight of engraved cylinder sample after SC-cleaning | 0.9562 g |
| residual polyvinyl on engraved cylinder sample | 0.0007 g |

### EXAMPLE 3

### Cleaning of Red Ink in Polyvinyl Resin Using a Supercritical Mixture of N-methyl pyrrolidone and CO₂

N-methylpyrrolidone (NMP) and CO₂ were mixed at weight ratios between 0.5 and 90% of NMP (preferably 80% of NMP by weight) in a mixer (internal volume 250 dm³). The solution was used in a pressure range of 80-300 bar (preferably at 140 bar) and in a temperature range of 30-100° C. (preferably at 40° C.). The solution was delivered to the cleaning autoclave with a variable flow rate ranging between 0.8 and 5 kg/h (preferably 0.8 kg/h). The autoclave (internal volume 500 dm³) was loaded with pieces of engraved cylinder (surface area 9 cm²) on which the polyvinyl resin plus red ink was previously spread. The cleaning was performed for a period of time ranging from 10 to 140 minutes (preferably 20 minutes).

Downstream the cleaning autoclave, the solution was sent to the first separator, that operates at pressures between 30 and 200 bar (preferably 80 bar) and temperatures ranging between 40 and −30° C. (preferably at 40° C.). The first separator allows the extracted ink precipitation and its recovery using the spray extraction technique.

The solution at the exit of the first separator is, then, delivered to the second separator operating at pressures between 15 and 10 bar (preferably 10 bar) and at temperatures between 0 and 25° C. (preferably 20° C.). In the second separator, NMP is precipitated and recovered by decompression, whereas CO₂ is separated as gas. The NMP recovered at the second separator still contains 4% by weight of red ink.

By operating at the process conditions of 140 bar, 40° C. with a flow rate of 0.8 kg/h for 20 min, with a N-methylpyrrolidone mass fraction of 80%, the following results were obtained:

| | |
|---|---|
| weight of engraved cylinder sample | 0.8862 g |
| weight of engraved cylinder sample dirty of polyvinyl red ink | 0.9075 g |
| weight of engraved cylinder sample after SC-cleaning | 0.8868 g |
| residual polyvinyl on engraved cylinder sample | 0.0006 g |

The present invention has been disclosed with particular reference to some specific embodiments thereof, but it should be understood that modifications and changes may be made by the persons skilled in the art without departing from the scope of the invention as defined in the appended claims.

1. A process for cleaning the cells of engraved cylinders used in printing and packaging industries from adhesive or ink residues, which process uses a mixture formed by one or more organic solvents and a fluid, and comprises the following steps:
a) forming the mixture in a mixer;
b) delivering said mixture in an autoclave previously filled with the engraved cylinders;
c) cleaning for a residence time of from 5 to 190 minutes;
d) eliminating the organic solvent residue in the autoclave by washing it with fluid;
e) precipitating the extracted inks or adhesives in one or more separators located downstream the autoclave, characterized in that said mixture is a supercritical mixture containing from 70 to 90% by weight of said one or more organic solvents and a supercritical fluid, in that said mixer is a vessel withstanding operating pressures up to 400 bar and in that said autoclave is a vessel withstanding operating pressures up to 400 bar.

2. A process according to claim 1, wherein in step e) the extracted residues are precipitated from the supercritical mixture by a spray extraction method.

3. A process according to claim 1, also comprising the following step:
f) depressurizing the supercritical mixture to recover the organic solvents and the supercritical fluid.

4. A process according to claim 1, wherein said super critical fluid is formed by one or more compounds chosen from the group consisting of: carbon dioxide, nitrogen protoxide, trifluoromethane, propane.

5. A process according to claim 1, wherein said one or more organic solvents are chosen from the group consisting of: acetone, chloroform, diethyl- or dimethylsulfoxide, ethyl acetate, propyl acetate, isopropyl acetate, n-butyl acetate, isobutyl acetate, methyl glycol acetate, amyl acetate, ethyl glycol acetate, methyl amyl acetate, tetrahydrofurane, methanol, ethanol, propanol, butanol, iso-butanol, n-hexane, cyclohexane, methyl furane, ethyl ether, N-methylpyrrolidone, furane, acetonitrile.

6. A process according to claim 1, wherein said engraved cylinders are used in film coupling processes and said adhesive residues are chosen from the group consisting of: polymaleic, polyacrylic, polyurethane, polyvinyl and polyamide resins.

7. A process according to claim 1, wherein said engraved cylinders are used in printing processes and said ink residues are formed by a system resin+additive+pigment, commonly used in printing industries and chosen from the group consisting of: systems with yellow, red, blue, violet, green, black pigment mixed with polymeric resins chosen from polymaleic, polyacrylic, polyurethane, polyvinyl and polyamide resins.

8. A process according to claim 1, wherein in the steps a) and b) the supercritical mixture operates at a pressure range between 40 and 400 bar.

9. A process according to claim 1, wherein in the steps a) and b) the supercritical mixture operates at a temperature range between 30 and 100° C.

10. A process according to claim 1, wherein in the step c) the residence time of the cylinders in the autoclave ranges between 10 and 145 minutes.
